(19) United States
(12) Patent Application Publication
(10) Pub. No.: US 2008/0114908 A1
(43) Pub. Date: May 15, 2008

(54) Media management systems and methods for portable devices

(75) Inventor: Shih-Chia Chien, Taichung (TW)

Correspondence Address: BIRCH STEWART KOLASCH & BIRCH, PO BOX 747, FALLS CHURCH, VA, 22040-0747, US

(73) Assignee: ULEAD SYSTEMS, INC.

(21) Appl. No.: 11/595,926

(22) Filed: Nov. 13, 2006

(51) Int. Cl. G06F 13/38

(52) U.S. Cl. 710/33

(57) ABSTRACT

Media management systems and methods for portable devices. A media management system comprises a portable device and a host coupled to the portable device. The portable device or the host analyzes media properties for the portable device. The host generates a media template according to the media properties, generates test media based on the media template, and transmits the test media to the portable device for playback. If the test media has been played back normally on the portable device, the host stores the media template. In the future, source media can be converted according to the media template, and transmitted to the portable device for playback.

### BACKGROUND OF THE INVENTION

1. Field of the Invention

The disclosure relates generally to media management, and, more particularly to systems and methods for media template configuration, providing media on portable devices.

2. Description of the Related Art

Portable devices collectively refer to various portable appliances comprising handheld devices, such as mobile phones, smart phones, Personal Digital Assistants (PDAs), handheld game consoles, handheld video players and Digital Still Cameras (DSCs). Recently, portable devices have become more and more advanced, with built-in advanced functionality such as media recording and playback capabilities.

Generally, media from any source device such as DSC, DV, VCD/DVD, HD-DVD, Blu-ray Disc, mobile phone, and network, can be imported to portable devices for playback. However, such portable devices are considerably different in their compatibility since they are from different manufacturers and in different hardware and software platforms. The media may not be compatible and played back in the portable devices since the media format may be different.

FIG. 1 is a schematic diagram illustrating a process for importing media to portable devices. As shown in FIG. 1, source devices 110 comprise DSC 111, DV 112, VCD/DVD/HD DVD/Blu-ray Disc 113, mobile phone 114 and network 115. Media from the source devices 110 may be in different media formats such as MPEG, AVI, MOV, WMV, RM, MP4, DVR-MS, M2T, BDAV, VRO, SRO and 3GP. Since most portable devices 130 support MP4, 3GP and AVI, most source media must be first input to a processing device 120 such as a computer for format conversion, and the converted media are imported to the portable devices 130 for playback.

Conventionally, media are converted according to the specifications provided by the manufacturers of the portable devices. This is inflexible and limited to some portable devices. Software provides a function for manually setting related parameters for media conversion, although lack of user experience with complex process often results in failure. For example, the converted media may be video with no audio, audio with no video, or the resolution of the converted media may not match the display of a device. Parameters must be set by trial and error, an inconvenient and time-consuming method.

### BRIEF SUMMARY OF THE INVENTION

Media management systems and methods for portable devices are provided.

An embodiment of a media management system for portable devices comprises a portable device comprising media, and a host coupled to the portable device. The portable device exports the media to the host. The host receives the media, and analyzes the media to obtain properties of the media. The host generates a media template according to the properties.

An embodiment of a media management system for portable devices comprises a portable device, and a host coupled to the portable device. The portable device comprises an application analyzing media properties for the portable device, exporting the media properties to the host. The host receives the media properties, and generates a media template according to the media properties.

An embodiment of a media management system for portable devices comprises a portable device, and a host coupled to the portable device. The host comprises an application analyzing media properties for the portable device, and generates a media template according to the media properties.

In an embodiment of a media management method for portable devices, a portable device and a host coupled to the portable device are provided. Media properties are analyzed for the portable device by the portable device or the host. The host generates a media template according to the media properties.

Media management systems and methods for portable devices may take the form of program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating a process for importing media to portable devices;

FIG. 2 is a schematic diagram illustrating an embodiment of a media management system;

FIG. 3 is a schematic diagram illustrating another embodiment of a media management system;

FIG. 4 is a schematic diagram illustrating still another embodiment of a media management system;

FIG. 5 is a flowchart of an embodiment of a media management method;

FIG. 6 is a flowchart of another embodiment of a media management method; and

FIG. 7 is a flowchart of still another embodiment of a media management method.

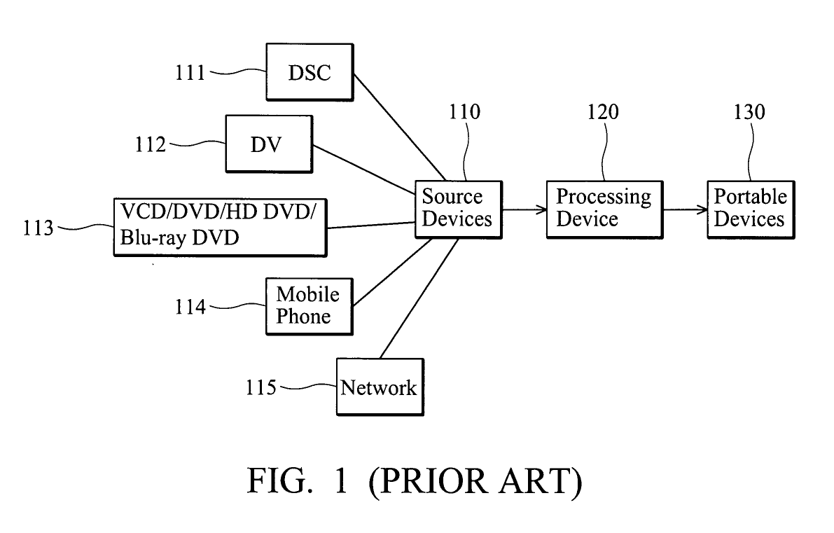

### DETAILED DESCRIPTION OF THE INVENTION

Media management systems and methods for portable devices are provided.

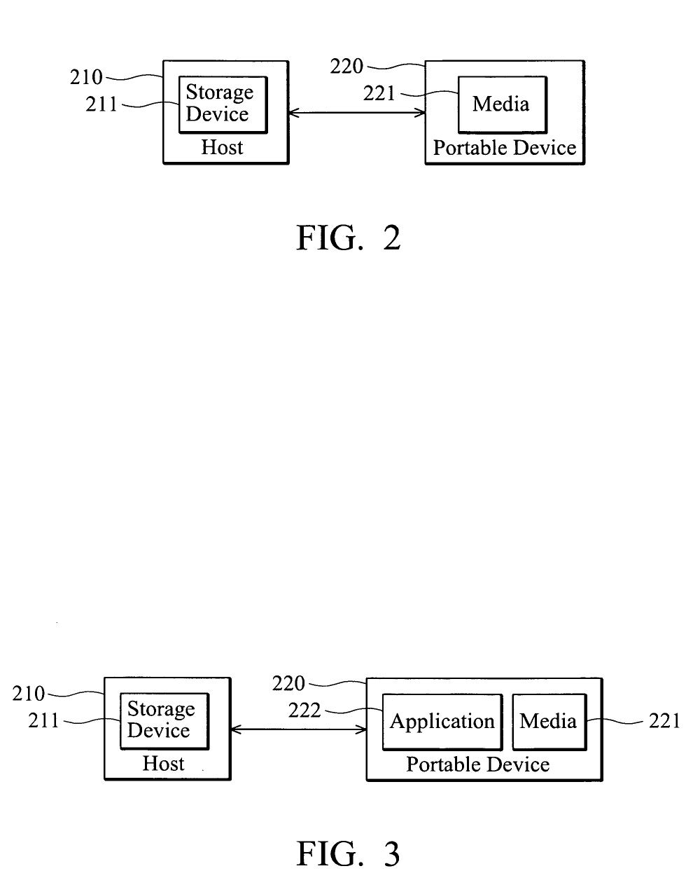

FIG. 2 is a schematic diagram illustrating an embodiment of a media management system. As shown in FIG. 2, the media management system comprises a host 210 such as a computer, and a portable device 220 such as a mobile phone, a smart phone, a PDA, a handheld game console, a handheld video player, or a DSC. The host 210 comprises a storage device 211 such as floppy diskettes, DVD, HD-DVD, Blu-ray Disc, Flash Memory, hard drives, or any other recordable storage medium storing related data for media management. The portable device 220 comprises media 221 such as movies comprising video and/or audio content. Besides, media 221 can be images, animation, slideshow, sound, voice or one of each combination, and others. It is understood that the media 221 is compatible with the portable device 220, and can be played back normally on the portable device 220. The portable device 220 can export the media 221 to the host 210. The host 210 can analyze the media 221 to obtain media properties thereof. The media properties comprise total frames, a resolution, an aspect ratio, a color depth, a frame rate, a data rate, an audio type, total samples, a sample rate, a bit rate, a channel, or a sample depth, and others.

The host 210 can generate a media template such as a movie template according to the media properties, and store the media template to the storage device 211. In some embodiments, the host 210 can generate test media such as a test movie according to the media template, and transmit the test media to the portable device 220 for playback. If the test media are played back normally, a signal indicating the test media has been played back normally on the portable device can be transmitted to the host 210, and the host 210 stores the media template to the storage device 211 in response to the signal. Further, the host 210 can convert source media (not shown) according to the media template, and transmit the converted source media to the portable device 220, such that the converted source media can be played back normally on the portable device 220.

FIG. 3 is a schematic diagram illustrating another embodiment of a media management system. As shown in FIG. 3, the media management system comprises a host 210, and a portable device 220. The host 210 comprises a storage device 211 storing related data for media management. The portable device 220 comprises media 221 such as movies comprising video and/or audio content, and an application 222. Besides, media 221 can be images, animation, slideshow, sound, voice or one of each combination, and others. Similarly, the media 221 is compatible with the portable device 220, and can be played back normally on the portable device 220. In this embodiment, the analysis of media properties is performed in the portable device 220. The application 222 can analyze the media 221 to obtain media properties thereof. Similarly, the media properties comprise total frames, a resolution, an aspect ratio, a color depth, a frame rate, a data rate, an audio type, total samples, a sample rate, a bit rate, a channel, or a sample depth, and others. Additionally, if the portable device 220 supports JAVA technology, for example, with built-in J2ME, the application 222 can directly analyze the portable device 220 to obtain the media properties using function calls, such as Mobile Media API (MMAPI) and others. After the analysis, the portable device 220 outputs the media properties to the host 210.

Similarly, the host 210 can generate a media template such as a movie template according to the media properties, and store the media template to the storage device 211. In some embodiments, the host 210 can generate test media such as a test movie according to the media template, and transmit the test media to the portable device 220 for playback. If the test media are played back normally, a signal indicating the test media has been played back normally on the portable device can be transmitted to the host 210, and the host 210 stores the media template to the storage device 211 in response to the signal. Further, the host 210 can convert source media (not shown) according to the media template, and transmit the converted source media to the portable device 220, such that the converted source media can be played back normally on the portable device 220.

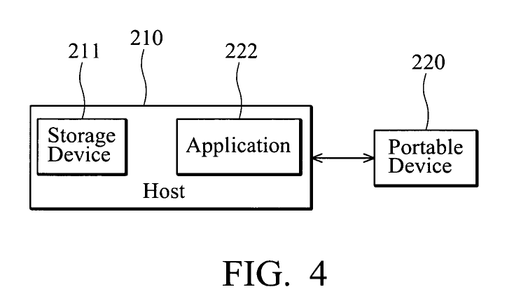

FIG. 4 is a schematic diagram illustrating still another embodiment of a media management system. As shown in FIG. 4, the media management system comprises a host 210, and a portable device 220. The host 210 comprises a storage device 211 storing related data for media management, and an application 222. In this embodiment, the analysis of media properties is performed in the host 210. The application 222 can directly analyze the portable device 220 to obtain the media properties for the portable device 220. Similarly, the media properties comprise total frames, a resolution, an aspect ratio, a color depth, a frame rate, a data rate, an audio type, total samples, a sample rate, a bit rate, a channel, or a sample depth, and others.

Similarly, the host 210 can generate a media template such as a movie template according to the media properties, and store the media template to the storage device 211. In some embodiments, the host 210 can generate test media such as a test movie according to the media template, and transmit the test media to the portable device 220 for playback. If the test media are played back normally, a signal indicating the test media has been played back normally on the portable device can be transmitted to the host 210, and the host 210 stores the media template to the storage device 211 in response to the signal. Further, the host 210 can convert source media (not shown) according to the media template, and transmit the converted source media to the portable device 220, such that the converted source media can be played back normally on the portable device 220.

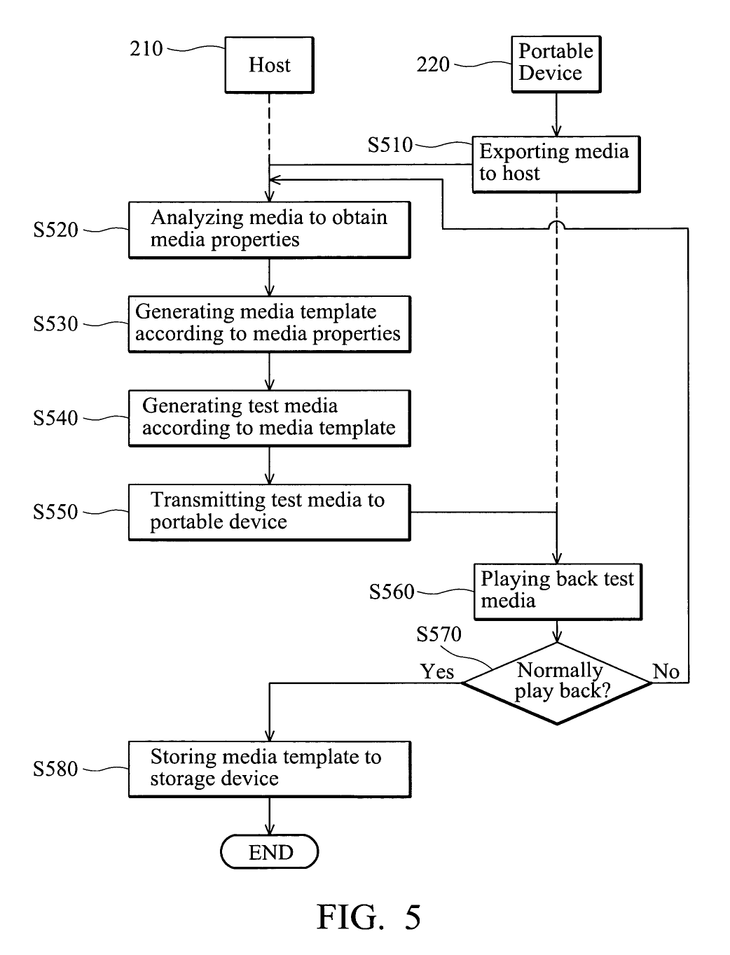

FIG. 5 is a flowchart of an embodiment of a media management method. In this embodiment, the analysis of media properties is performed in the host 210.

In step S510, the portable device 220 exports the media 221 to the host 210. Media 221 can be movies comprising video and/or audio content. Besides, media 221 also can be images, animation, slideshow, sound, voice or one of each combination, and others. In step S520, the host 210 analyzes the media 221 to obtain media properties thereof. The media properties comprise total frames, a resolution, an aspect ratio, a color depth, a frame rate, a data rate, an audio type, total samples, a sample rate, a bit rate, a channel, or a sample depth, and others. In step S530, the host 210 generates a media template such as a movie template according to the media properties, and in step S540, generates test media such as a test movie according to the media template. In step S550, the host 210 transmits the test media to the portable device 220 for playback. In step S560, the portable device 220 plays back the test media. If the test media are played back normally (Yes in step 5470), in step S580, the host 210 stores the media template to the storage device 211. It is understood that a signal indicating the test media has been played back normally on the portable device is transmitted to the host 210 if the test media are played back normally, and the host 210 stores the media template to the storage device 211 in response to the signal. If the test media cannot be played back normally (No in step S570), the procedure returns to step S520, and the host 210 analyzes other media exported from the portable device 220. It is understood that since the portable device may have several media, if all media are analyzed and no corresponding test media can be played back normally on the portable device 220, the procedure is terminated.

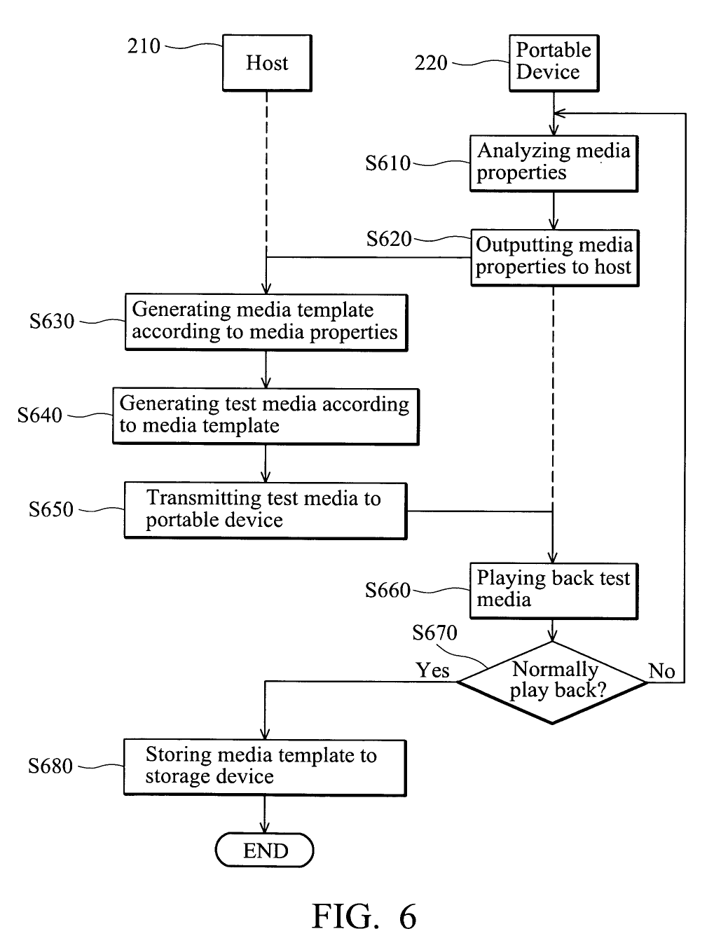

FIG. 6 is a flowchart of another embodiment of a media management method. In this embodiment, the analysis of media properties is performed on the portable device 220.

In step S610, the media properties are analyzed for the portable device 220. Similarly, the media properties comprise total frames, a resolution, an aspect ratio, a color depth, a frame rate, a data rate, an audio type, total samples, a sample rate, a bit rate, a channel, or a sample depth, and others. If the portable device 220 supports JAVA technology, for example, with built-in J2ME, the application 222 can directly analyze the portable device 220 to obtain the media properties using function calls, such as Mobile Media API (MMAPI) and others. It is understood that the analysis of media properties may be performed by the application 222 on the portable device 220 analyzing the media 221, or the application 222 on the portable device 220 directly analyzing the portable device 220 to obtain the media properties. In step S620, the portable device 220 outputs the media properties to the host 210. In step S630, the host 210 generates a media template such as a movie template according to the media properties, and in step S640, generates test media such as a test movie according to the media template. In step S650, the host 210 transmits the test media to the portable device 220 for playback. In step S660, the portable device 220 plays back the test media. If the test media are played back normally (Yes in step S670), in step S680, the host 210 stores the media template to the storage device 211. Similarly, a signal indicating the test media has been played back normally on the portable device is transmitted to the host 210 if the test media are played back normally, and the host 210 stores the media template to the storage device 211 in response to the signal. If the test media cannot be played back normally (No in step S670), the procedure returns to step S610, and the media properties are analyzed again. It is understood that since the portable device may have several media, if all media are analyzed and no corresponding test media can be played back normally on the portable device 220, the procedure is terminated.

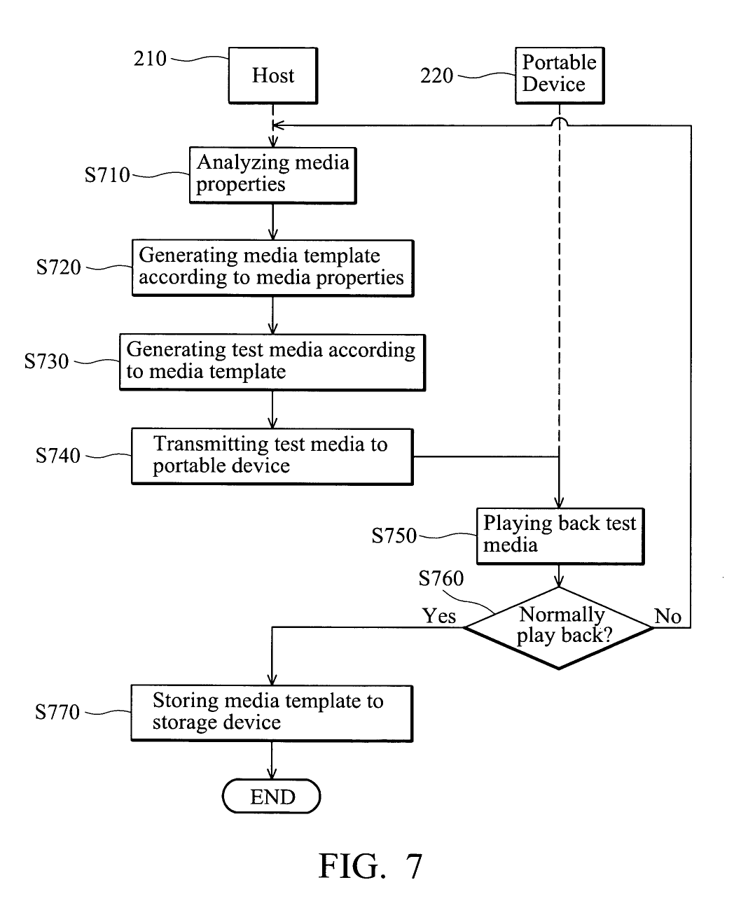

FIG. 7 is a flowchart of still another embodiment of a media management method. In this embodiment, the analysis of media properties is performed in the host 210.

In step S710, the media properties are analyzed for the portable device 220. Similarly, the media properties comprise total frames, a resolution, an aspect ratio, a color depth, a frame rate, a data rate, an audio type, total samples, a sample rate, a bit rate, a channel, or a sample depth, and others. The analysis of media properties is performed by the application 222 on the host 210 directly analyzing the portable device 220 to obtain the media properties. In step S720, the host 210 generates a media template such as a movie template according to the media properties, and in step S730, generates test media such as a test movie according to the media template. In step S740, the host 210 transmits the test media to the portable device 220 for playback. In step S750, the portable device 220 plays back the test media. If the test media are played back normally (Yes in step S760), in step S770, the host 210 stores the media template to the storage device 211. Similarly, a signal indicating the test media has been played back normally on the portable device is transmitted to the host 210 if the test media are played back normally, and the host 210 stores the media template to the storage device 211 in response to the signal. If the test media cannot be played back normally (No in step S760), the procedure returns to step S710, and the media properties are analyzed again. In some embodiments, if the analyses of the media properties are performed for a predefined times, the procedure is terminated.

After the media template is generated, any source media can be converted according to the media template, and the converted media can be compatible with the portable device, and played back normally thereon. In the media conversion, the media properties are first retrieved from the media template. The media properties and some necessary properties such as media length of source media are combined, and new media is generated according to the media content of source media and the combined media properties.

Media management systems and methods for portable devices, or certain aspects or portions thereof, may take the form of program code (i.e., executable instructions) embodied in tangible media, such as floppy diskettes, CD-ROMS, DVD, HD-DVD, Blu-ray Disc, Flash Memory, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A media management system for portable devices, comprising:
a portable device comprising media, exporting the media; and
a host coupled to the portable device, receiving the media, analyzing the media to obtain properties of the media, and generating a media template according to the properties.

2. The system of claim 1 wherein the host further generates test media based on the media template, and transmits the test media to the portable device.

3. The system of claim 2 wherein the portable device further plays back the test media, and transmits a signal indicating the test media has been played back normally on the portable device, and the host further stores the media template to a storage device in response to the signal.

4. The system of claim 1 wherein the properties comprise total frames, a resolution, an aspect ratio, a color depth, a frame rate, a data rate, an audio type, total samples, a sample rate, a bit rate, a channel, or a sample depth.

5. The system of claim 1 wherein the host further converts source media according to the media template, and transmits the converted source media to the portable device for playback.

6. The system of claim 1 wherein the portable device comprises a mobile phone, a smart phone, a PDA, a handheld game console, a handheld video player or a digital still camera.

7. A media management system for portable devices, comprising:
a portable device comprising an application analyzing media properties for the portable device, and exporting the media properties; and
a host coupled to the portable device, receiving the media properties, and generating a media template according to the media properties.

8. The system of claim 7 wherein the host further generates test media based on the media template, and transmits the test media to the portable device.

9. The system of claim 8 wherein the portable device further plays back the test media, and transmits a signal indicating the test media has been played back normally on the portable device, and the host further stores the media template to a storage device in response to the signal.

10. The system of claim 7 wherein the media properties comprise total frames, a resolution, an aspect ratio, a color depth, a frame rate, a data rate, an audio type, total samples, a sample rate, a bit rate, a channel, or a sample depth.

11. The system of claim 7 wherein the host further converts source media according to the media template, and transmits the converted source media to the portable device for playback.

12. The system of claim 7 wherein the portable device comprises a mobile phone, a smart phone, a PDA, a handheld game console, a handheld video player or a digital still camera.

13. The system of claim 7 wherein the application analyzes media on the portable device to obtain the media properties.

14. The system of claim 7 wherein the application directly analyzes the portable device to obtain the media properties.

15. A media management system for portable devices, comprising:
a portable device; and
a host coupled to the portable device, comprising an application analyzing the portable device to obtain media properties for the portable device, and generating a media template according to the media properties.

16. The system of claim 15 wherein the host further generates test media based on the media template, and transmits the test media to the portable device.

17. The system of claim 16 wherein the portable device further plays back the test media, and transmits a signal indicating the test media has been played back normally on the portable device, and the host further stores the media template to a storage device in response to the signal.

18. The system of claim 15 wherein the media properties comprise total frames, a resolution, an aspect ratio, a color depth, a frame rate, a data rate, an audio type, total samples, a sample rate, a bit rate, a channel, or a sample depth.

19. The system of claim 15 wherein the host further converts source media according to the media template, and transmits the converted source media to the portable device for playback.

20. The system of claim 15 wherein the portable device comprises a mobile phone, a smart phone, a PDA, a handheld game console, a handheld video player or a digital still camera.

21. A media management method for portable devices, comprising:
providing a portable device and a host coupled to the portable device;
analyzing media properties for the portable device; and
the host generating a media template according to the media properties.

22. The method of claim 21 further comprising:
the portable device exporting media to the host; and
the host analyzing the media to obtain the media properties.

23. The method of claim 21 further comprising:
an application in the portable device analyzing media to obtain the media properties; and
the portable device exporting the media properties to the host.

24. The method of claim 21 further comprising:
an application in the portable device directly analyzing the portable device to obtain the media properties; and
the portable device exporting the media properties to the host.

25. The method of claim 21 further comprising an application in the host directly analyzing the portable device to obtain the media properties.

26. The method of claim 21 further comprising the host generating test media based on the media template, and transmitting the test media to the portable device.

27. The method of claim 26 further comprising:
the portable device playing back the test media, and transmitting a signal indicating the test media has been played back normally on the portable device; and
the host storing the media template to a storage device in response to the signal.

28. The method of claim 21 wherein the media properties comprise total frames, a resolution, an aspect ratio, a color depth, a frame rate, a data rate, an audio type, total samples, a sample rate, a bit rate, a channel, or a sample depth.

29. The method of claim 21 further comprising the host converting source media according to the media template, and transmitting the converted source media to the portable device for playback.

30. The method of claim 21 wherein the portable device comprises a mobile phone, a smart phone, a PDA, a handheld game console, a handheld video player or a digital still camera.
